(19) United States
(12) Patent Application Publication
(10) Pub. No.: US 2019/0196944 A1
(43) Pub. Date: Jun. 27, 2019

(54) SYSTEM FOR WRITING AND EXECUTING UNIT TEST CASES

(71) Applicant: International Business Machines Corporation, Armonk, NY (US)

(72) Inventors: Manish Bhide, Hyderabad (IN); Yamini Danthuluri, Hyderabad (IN); Hari Kiran Maddela, Hyderabad (IN)

(21) Appl. No.: 15/852,611

(22) Filed: Dec. 22, 2017

(51) Int. Cl. G06F 11/36

(52) U.S. Cl. CPC G06F 11/3684; G06F 11/3688; G06F 11/3664; G06F 11/3692

(57) ABSTRACT

A unit test case framework system writes unit test case(s) by passing only module input parameter value(s) that need to be tested, instead of passing all the input parameter value(s).

### BACKGROUND

The present invention relates to methods of testing computer software code, and more specifically to methods of testing computer software code in the form of program modules or functions.

When a module has been written, it needs to be tested with various values for input parameters to make sure that the module will operate correctly in use. This can be done by creating unit test cases for the module. A unit test case system needs to make sure that all the module input parameter values are passed to the module that is being tested, even though the unit test case is to test the module for one specific parameter with a specific value.

Currently, no existing Integrated Development Environment (IDE) has the capability to test the module for one specific parameter with one specific value. An IDE is a software application that provides comprehensive facilities to computer programmers for software development. An IDE normally consists of a source code editor, build automation tools and a debugger. Most modern IDEs have intelligent code completion. Some IDEs, such as NetBeans and Eclipse, contain a compiler, interpreter, or both; others, such as SharpDevelop and Lazarus, do not.

At present there are different methods or approaches to write unit test cases, for example:

1. Invoking test modules directly from other classes or writing wrapper modules/classes. For example, a class is a template for creating different objects which define its properties and behaviors. The template can contain fields and methods to describe the behavior of an object. A JAVA class is an example.

2. Writing test cases in the form of XML/JSON or any other external based format/structure.

3. Dynamically generating test classes by reading module information from external file systems i.e. XML or any other format.

4. Invoking test modules with the data sets reading from CSV file etc.

All of the above mentioned methods are required to pass all the module input parameter values to the module that is being tested. This would create duplication of input parameter values and more maintenance cost in case of change in module signature.

Suppose, for example, there is a test module createAccount( ) with the signature and some implementation logic. The test module can be represented by a segment of code, as follows:

void createAccount(String customer_id, String acc_no, String
first_name, String
last_name, String address1, String address2,
String city, String pin-code, String state, String country, String
contact_no)
{
--The code to perform the function would be here--
}

First unit test cases are written for this module for all the module parameters. The below techniques explain different existing approaches to test the above createAccount( ) module with different customer_id values.

Approach 1: Writing unit test cases by invoking test module

The code for this invoking a test module could be as follows:

// test case to check valid entry of the customer_id
@Test
public void testcase_1( ) throws Exception{
createAccount( ″C0001″, ″CODE-0123456789″, ″firstname″, ″lastname″,
″address1″, ″address2″,
″city″, ″pin-code″, ″state″, ″country″, 123456789);
-------
String actual_customer_id=” get customer_id value from database”;
assert(″C00001″, actual_customer_id);
// pass or fail test case
}
// test case to check boundary value of the customer_id
@Test
public void testcase_2( ) throws Exception{
createAccount( ″C000000001″, ″CODE-0123456789″, ″firstname″,
″lastname″,
″address1″, ″address2″,
″city″, ″pin-code″, ″state″, ″country″, 123456789);
-------
String actual_customer_id=” get customer_id value from database”;
assert(″C000000001″, actual_customer_id);
// pass or fail test case
}
// test case to check empty value of the customer_id
@Test
public void testcase_3( ) throws Exception{
createAccount(″″, ″CODE-0123456789″, ″firstname″, ″lastname″,
″address1″,
″address2″,
″city″, ″pin-code″, ″state″, ″country″, 123456789);
.....
assert(″″, actual_customer_id); or check proper error message
}

Approach 1: Creating wrapper modules:

The building wrapper module approach includes additional efforts depending up on the permutation and combination of input parameters and their values and with every new parameter, this will increase exponentially (not linear).

Suppose in a given test scenario, multiple parameter values have to change and a combination of testing has to occur. As an example:

1) Testing customer_id independently takes values from 1 to 20 as well as null, −1, etc.

2) Testing acc_id independently, takes values of 2000 to 5000 as well as −1, “ ”, special characters, etc.

3) Combination of two parameters i.e. customer_id,acc_no.

With the wrapper module three wrapper functions have to be written, which is called createAccountwrapper-1, createAccountwrapper-2 and createAccountwrapper-3, as follows:

createAccountwrapper_1(String customer_id)

{
String acc_no=″CODE-0123456789″;
String first_name=”firstname”;
String last_name=”lastname”,
String address1=”some address 1”
String address2=”some address 2”
String city=”some city”
String pin-code=”123234”
String state=”some state”
String country=”some country”
String contact_no=”748374934049”
createAccount(customer_id, acc_no, first_name, last_name,
address1, address2,
city, pin-code, state, country, contact_no);
string actual_customer_id=”get customer_id value from database”;

assert(a, actual_customer_id);

}

createAccountwrapper_2(String acc_no)

{
String customer_id =″some cust id″;
String first_name=”firstname”;
String last_name=”lastname”,
String address1=”some address 1”
String address2=”some address 2”
String city=”some city”
String pin-code=”123234”
String state=”some state”
String country=”some country”
String contact_no=”748374934049”
createAccount(customer_id, acc_no, first_name, last_name,
address1, address2,
city, pin-code, state, country, contact_no);
string actual_customer_id=”get customer_id value from database”;

assert(a, actual_customer_id);

}

createAccountwrapper_3(String customer_id,String acc_no)

{
String first_name=”firstname”;
String last_name=”lastname”,
String address1=”some address 1”
String address2=”some address 2”
String city=”some city”
String pin-code=”123234”
String state=”some state”
String country=”some country”
String contact_no=”748374934049”
createAccount(customer_id, acc_no, first_name, last_name,
address1, address2,
city, pin-code, state, country, contact_no);
string actual_customer_id=”get customer_id value from database”;

assert(a, actual_customer_id);

}

Approach 2: The same above createAccount( ) module unit test cases can be written by passing parameters through XML/JSON,

Approach 2 is as follows:

<testcase name=″testcase_1″>
<parameter name=″customer_id″ value=″C00001″ />
<parameter name=″account_no″ value=″CODE-0123456789″ />
<parameter name=″first_name″ value=″abc″ />
<parameter name=″last_name″ value=″xyz″ />
<parameter name=″address1″ value=″house no″ />
<parameter name=″address2″ value=″flat no and flat name and area″ />
<parameter name=″city″ value=″Hyderabad″ />
<parameter name=″pin-code″ value=″500081″ />
<parameter name=″state″ value=″Telangana″ />
<parameter name=″country″ value=″India″ />
<parameter name=″contact_no″ value=″7923723044″ />
</testcase>
<testcase name=″testcase_2″>
<parameter name=″customer_id″ value=″C0000111″ />
<parameter name=″account_no″ value=″CODE-0123456789″ />
<parameter name=″first_name″ value=″abc″ />
<parameter name=″last_name″ value=″xyz″ />
<parameter name=″address1″ value=″house no″ />
<parameter name=″address2″ value=″flat no and flat name and area″ />
<parameter name=″city″ value=″Hyderabad″ />
<parameter name=″pin-code″ value=″500081″ />
<parameter name=″state″ value=″Telangana″ />
<parameter name=″country″ value=″India″ />
<parameter name=″contact_no″ value=″7923723044″ />
</testcase>
<testcase name=″testcase_3″>
<parameter name=″customer_id″ value=″″ />
<parameter name=″account_no″ value=″CODE-0123456789″ />
<parameter name=″first_name″ value=″abc″ />
<parameter name=″last_name″ value=″xyz″ />
<parameter name=″address1″ value=″house no″ />
<parameter name=″address2″ value=″flat no and flat name and area″ />
<parameter name=″city″ value=″Hyderabad″ />
<parameter name=″pin-code″ value=″500081″ />
<parameter name=″state″ value=″Telangana″ />
<parameter name=″country″ value=″India″ />
<parameter name=″contact_no″ value=″7923723044″ />
</testcase>

Approach 3: Preparing data sets from a comma-delimited (CSV) file.

Such a file for the above case would look like this:

customer_id, account_no,first_name,last_name,address1,address2,city,pin-
code,state,country,contact_no
C00001,CODE-0123456789,abc,xyz,house no,flat no and flat name and
area,Hyderabad,500081,Telangana,India,123456789
C000011,CODE-0123456789,abc,xyz,house no,flat no and flat name and
area,Hyderabad,500081,Telangana,India,123456789
,CODE-0123456789,abc,xyz,house no,flat no and flat name and
area,Hyderabad,500081,Telangana,India,123456789

Approach 4: Directly generating classes at run time with the parameters mentioned above, in the form of external files like XML.

If the above mentioned approaches, all the parameters values have been duplicated except the testing parameter i.e. “customer_id”. These existing approaches would lead to unnecessary data duplication and huge maintenance cost when the module signature is changed.

For example, suppose the programmer needs to add one more parameter—for example, “UID”—to the createAccount( ) module. In this case all the existing test cases will break and more maintenance is involved for the existing test cases to PASS, that is adding UID parameter in all the test cases in all the above mentioned approaches.

### SUMMARY

According to one embodiment of the present invention, a method generating a test case for a module is disclosed. The method comprising the steps of: a computer receiving a class module selection for generation of a test case from a user; the computer receiving default values for each parameter of the test case from the user; the computer receiving parameters values to be varied during the test case from the user; the computer testing the module by varying only individual parameter values and combinations of parameter values; and the computer generating a report of results of the test case.

According to another embodiment of the present invention a computer program product for generating a test case for a module by a computer is disclosed. The computer comprising at least one processor, one or more memories, one or more computer readable storage media. The computer program product comprising a computer readable storage medium having program instructions embodied therewith. The program instructions executable by the computer to perform a method comprising: receiving, by the computer, a class module selection for generation of a test case from a user; receiving, by the computer, default values for each parameter of the test case from the user; receiving, by the computer, parameters values to be varied during the test case from the user; testing, by the computer, the module by varying only individual parameter values and combinations of parameter values; and generating, by the computer, a report of results of the test case.

According to another embodiment of the present invention, a computer system for generating a test case for a module is disclosed. The computer system comprising a computer comprising at least one processor, one or more memories, one or more computer readable storage media having program instructions executable by the computer to perform the program instructions. The program instructions comprising: receiving, by the computer, a class module selection for generation of a test case from a user; receiving, by the computer, default values for each parameter of the test case from the user; receiving, by the computer, parameters values to be varied during the test case from the user; testing, by the computer, the module by varying only individual parameter values and combinations of parameter values; and generating, by the computer, a report of results of the test case.

### BRIEF DESCRIPTION OF THE DRAWINGS

FIG. 1 depicts an exemplary diagram of a possible data processing environment in which illustrative embodiments may be implemented.

FIG. 2 illustrates internal and external components of a client computer and a server computer in which illustrative embodiments may be implemented.

FIG. 3 shows a flow diagram of a method of writing and executing unit test cases.

### DETAILED DESCRIPTION

The application programming interface (API) unit test case framework system of an embodiment of the present invention and presented herein is flexible to write and execute Unit Test Cases with minimal maintenance improving the efficiency of the computer and the testing of unit test cases. The unit test case framework system writes unit test case(s) by passing only module input parameter value(s) that need to be tested, instead of passing all the input parameter value(s). In other words, the unit test case writer is able to test a module by passing only specific parameter value(s) or a combination of parameters that need to be tested, instead of passing all the input parameter values in every unit test case.

With the above mentioned Unit Testing Framework system, a user can just provide the module input parameter value(s) and any other associated information in an interface, for example a Graphic User Interface (GUI) in the IDE.

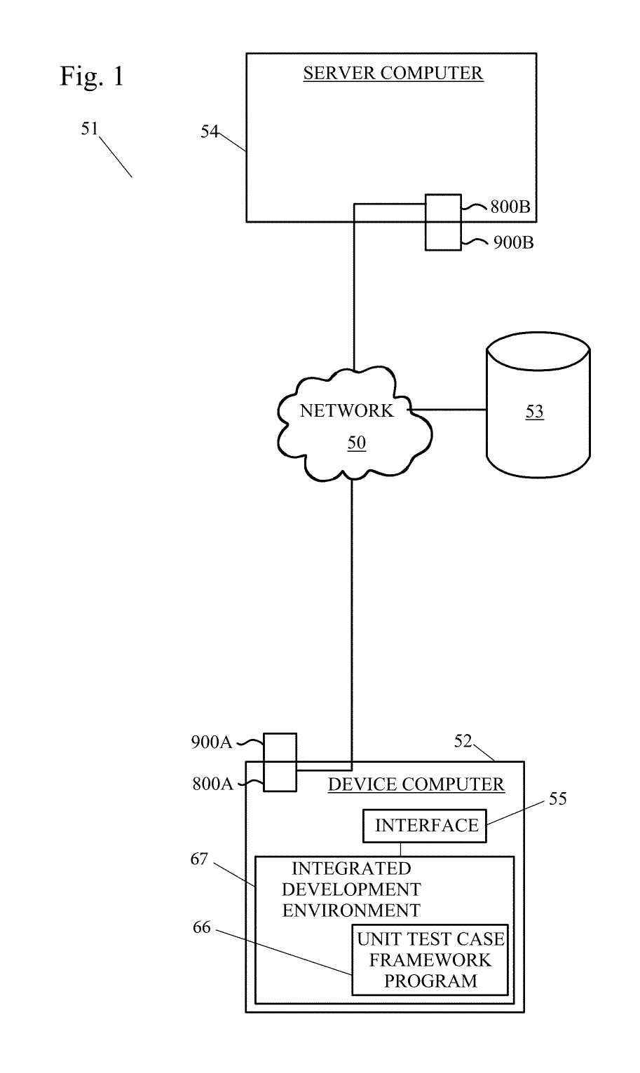

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, device computer 52, a repository 53, and a server computer 54 connect to network 50. In other exemplary embodiments, network data processing system 51 may include additional client or device computers, storage devices or repositories, server computers, and other devices not shown.

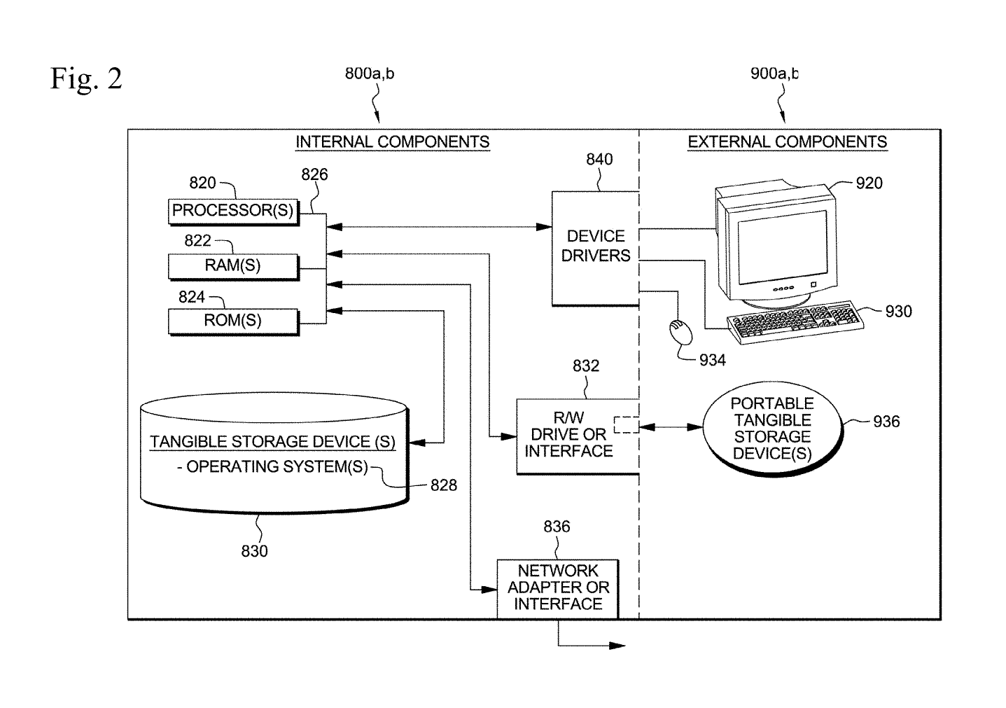

The device computer 52 may contain an interface 55, which may accept commands and data entry from a user. The commands may be regarding module input parameter value(s) for testing. The interface can be, for example, a command line interface, a graphical user interface (GUI), a natural user interface (NUI) or a touch user interface (TUI). The device computer 52 preferably includes an integrated development environment 67 with a unit test case framework program 66. While not shown, it may be desirable to have the unit test case framework program 66 be present on the server computer 54. The device computer 52 includes a set of internal components 800a and a set of external components 900a, further illustrated in FIG. 2.

Server computer 54 includes a set of internal components 800b and a set of external components 900b illustrated in FIG. 2. In the depicted example, server computer 54 provides information, such as boot files, operating system images, and applications to the device computer 52. Server computer 54 can compute the information locally or extract the information from other computers on network 50. The server computer 54 may contain the unit test case framework program 66.

Program code and programs such as unit test case framework program 66 and integrated development environment 67 may be stored on at least one of one or more computer-readable tangible storage devices 830 shown in FIG. 2, on at least one of one or more portable computer-readable tangible storage devices 936 as shown in FIG. 2, or on storage unit 53 connected to network 50, or may be downloaded to a device computer 52 or server computer 54, for use. For example, program code and programs such as unit test case framework program 66 and the integrated development environment 67 may be stored on at least one of one or more storage devices 830 on server computer 54 and downloaded to device computer 52 over network 50 for use. Alternatively, server computer 54 can be a web server, and the program code, and programs such as unit test case framework program 66 and integrated development environment 67 may be stored on at least one of the one or more storage devices 830 on server computer 54 and accessed device computer 52. In other exemplary embodiments, the program code, and programs such as unit test case framework program 66 may be stored on at least one of one or more computer-readable storage devices 830 on device computer 52 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

FIG. 2 illustrates internal and external components of a device computer 52 and server computer 54 in which illustrative embodiments may be implemented. In FIG. 1, a device computer 52 and a server computer 54 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and unit test case framework program 66 and integrated development environment 67 are stored on one or more of the computer-readable tangible storage devices 830 for execution by one or more of the processors 820 via one or more of the RAMs 822 (which typically include cache memory). In the embodiment illustrated in FIG. 2, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Unit test case framework program 66 and the integrated development environment 67 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Unit test case framework program 66 and the integrated development environment 67 can be downloaded to the device computer 52 and server computer 54 from an external computer via a network (for example, the Internet, a local area network or other, wide area network) and network adapter or interface 836. From the network adapter or interface 836, unit test case framework program 66 is loaded into hard drive 830. Unit test case framework program 66 and the integrated development environment 67 can be downloaded to the server computer 54 from an external computer via a network (for example, the Internet, a local area network or other, wide area network) and network adapter or interface 836. From the network adapter or interface 836, unit test case framework program 66 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Unit test case framework program 66 can be written in various programming languages including low-level, high-level, object-oriented or non object-oriented languages. Alternatively, the functions of a unit test case framework program 66 can be implemented in whole or in part by computer circuits and other hardware (not shown).

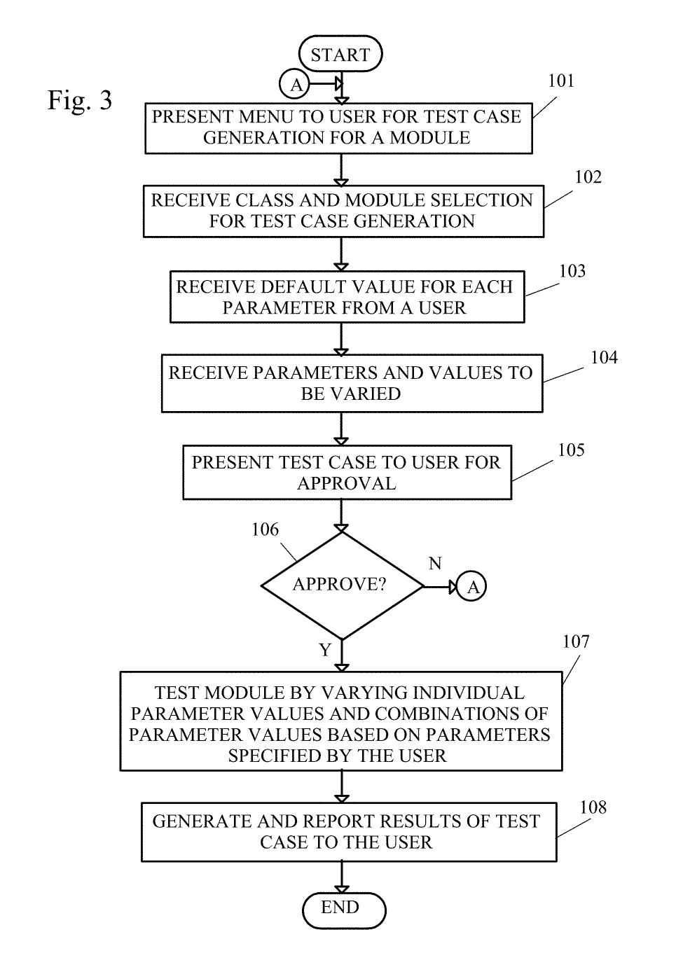

FIG. 3 shows a flow diagram of a method of writing and executing unit test cases.

In a first step, a menu is presented to the user via an interface, for example interface 55, for test case generation of a module (step 101).

The integrated development environment 67 receives class module and selection for test case generation (step 102).

The integrated development environment 67 then receives default values for each parameter of the test case (step 103). This information will be used during test case creation and execution, and will remain constant from test to test.

The integrated development environment 67 also receives parameters for which values are to be varied during test generation (step 104). The user selects the parameters for which the values are to be varied, as well as ranges or specific values to be used for the parameter. Based on the type of the parameter, the system may suggest values which will present typical problems for modules regarding that type of parameter. For example, if the parameter is of integer type, the system might suggest negative values, 0, etc. If the parameter is of string type, the system may suggest empty string, null, special characters, etc.

The test case to be generated for a module is then presented to the user via the interface (step 105).

If the integrated development environment 67 approves the test case generation and the associated parameters (step 106), the unit test case framework program 66 of the integrated development environment 67 tests the module by varying individual parameter values, as well as combinations of parameter values, based on the parameter specified by the user (step 107).

The unit test case framework program 66 generates a report of the results of the test case and displays the report to the user via an interface (step 108), for example interface 55 and the method ends.

Example of the system in operation:

Create File to Specify Parameters

Create an xml file, for example “TestCase.xml”, to specify the parameters of the module to be tested, with module(s) parameters and default parameter values. Note that the xml can be replaced with JSON or any structure format representation. But the following steps explains with XML representation.

<?xml version=“1.0” encoding=“utf-8”?>
<!-- This is the actual module signature with default parameter values.
Here
<createAccount> tag represents createAccount module. And the module
can be
represented in many ways in XML file. -- >
<createAccount>
<parameter name=“account_no” value=“ 123456789” />
<parameter name=“customer_id” value=“C0000” />
<parameter name=“first_name” value=“abc” />
<parameter name=“last_name” value=“xyz”/>
<parameter name=“address1” value=“house no” />
<parameter name=“address2” value=“flat no and flat name and area” />
<parameter name=“city” value= “Hyderabad” />
<parameter name=“pin-code” value=“500081” />
<parameter name=“state” value=“Telangana” />
<parameter name=“country” value=“India” />
<parameter name=“contact_no” value=“7923723044” />
</createAccount>

Write Unit Test Cases

In this example, the module will be tested by writing and executing test cases with different customer_id value, keeping all the remaining values with default values along with pre-assertions. Three test cases are provided for the example, although others can also be written.

<testcase name=“testcase_1”>

<createAccount>

<parameter name=“customer_id” value=“C00001” />

</createAccount>
<assert>customer_id</assert> // here we can have multiple comma

separated parameter names which need to be validated with
expected and actual values with test case results.

</testcase>
<testcase name=“ testcase_2”>

<createAccount>

<parameter name=“customer_id” value=“C000011” />

</ createAccount >
<assert>customer_id</assert>

</testcase>
<testcase name=“ testcase_3”>

<createAccount>

<parameter name=“customer_id” value=“” />

</createAccount>
<assert>customer_id</assert>

</testcase>

This approach provides the ability to pass only the parameter value(s) that are supposed to be tested rather than passing all the parameter values for every test case. And this will remove passing duplicate values as well. The parameter values can be fetched from DataSets from external files such as CSV files.

This approach provides more flexibility to test individual parameters with other parameters as defaults.

Now, consider the example which was mentioned above, where the programmer needs to add a new parameter—say UID—and then wants to execute the already written test cases without modifying anything with respect to test cases. This can be easily achieved by adding new parameter(s) to the <createAccount> tag with default value.

<createAccount>
<parameter name=″account_no″ value=″123456789″ />
<parameter name=″customer_id″ value=″C0000″ />
<parameter name=″first_name″ value=″abc″ />
<parameter name=″last_name″ value=″xyz″ />
<parameter name=″address1″ value=″house no″ />
<parameter name=″address2″ value=″flat no and flat name and area″ />
<parameter name=″city″ value= ″Hyderabad″ />
<parameter name=″pin-code″ value=″500081″ />
<parameter name=″state″ value=″Telangana″ />
<parameter name=″country″ value=″Indi″ />
<parameter name=″contact_no″ value=″7923723044″ />
<parameter name=”UID” value=”ABCED00032”/>
</createAccount>

With this approach the changes in the module signatures can also be handled very easily without breaking any existing test cases resulting low maintenance cost.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method generating a test case for a module comprising the steps of:
a computer receiving a class module selection for generation of a test case from a user;
the computer receiving default values for each parameter of the test case from the user;
the computer receiving parameters values to be varied during the test case from the user;
the computer testing the module by varying only individual parameter values and combinations of parameter values; and
the computer generating a report of results of the test case.

2. The method of claim 1, wherein the class module and selection for generation of a test case takes place in an integrated development environment.

3. The method of claim 1, wherein the default values are constant between multiple tests of the test case.

4. The method of claim 1, wherein the values to be varied comprises a range of values.

5. The method of claim 1, wherein after receiving the parameters and the associated values to be varied during the test case, the computer suggesting values which historically present problems for the class module selected.

6. The method of claim 1, further comprising the step of the computer generating a module for testing and presenting the module to the user via an interface after the computer receives the parameters and associated values to be varied during the test case.

7. The method of claim 1, further comprising the step of the computer displaying the report to the user via an interface.

8. A computer program product for generating a test case for a module by a computer comprising at least one processor, one or more memories, one or more computer readable storage media, the computer program product comprising a computer readable storage medium having program instructions embodied therewith, the program instructions executable by the computer to perform a method comprising:
receiving, by the computer, a class module selection for generation of a test case from a user;
receiving, by the computer, default values for each parameter of the test case from the user;
receiving, by the computer, parameters values to be varied during the test case from the user;
testing, by the computer, the module by varying only individual parameter values and combinations of parameter values; and
generating, by the computer, a report of results of the test case.

9. The computer program product of claim 8, wherein the class module and selection for generation of a test case takes place in an integrated development environment.

10. The computer program product of claim 8, wherein the default values are constant between multiple tests of the test case.

11. The computer program product of claim 8, wherein the values to be varied comprises a range of values.

12. The computer program product of claim 8, wherein after receiving the parameters and the associated values to be varied during the test case, suggesting, by the computer, values which historically present problems for the class module selected.

13. The computer program product of claim 8, further comprising the program instructions of generating, by the computer, a module for testing and presenting the module to the user via an interface after the computer receives the parameters and associated values to be varied during the test case.

14. The computer program product of claim 8, further comprising the program instructions of displaying, by the computer, the report to the user via an interface.

15. A computer system for generating a test case for a module, the computer system comprising a computer comprising at least one processor, one or more memories, one or more computer readable storage media having program instructions executable by the computer to perform the program instructions comprising:
receiving, by the computer, a class module selection for generation of a test case from a user;
receiving, by the computer, default values for each parameter of the test case from the user;
receiving, by the computer, parameters values to be varied during the test case from the user;
testing, by the computer, the module by varying only individual parameter values and combinations of parameter values; and
generating, by the computer, a report of results of the test case.

16. The computer system of claim 15, wherein the class module and selection for generation of a test case takes place in an integrated development environment.

17. The computer system of claim 15, wherein the default values are constant between multiple tests of the test case.

18. The computer system of claim 15, wherein the values to be varied comprises a range of values.

19. The computer system of claim 15, wherein after receiving the parameters and the associated values to be varied during the test case, suggesting, by the computer, values which historically present problems for the class module selected.

20. The computer system of claim 15, further comprising the program instructions of generating, by the computer, a module for testing and presenting the module to the user via an interface after the computer receives the parameters and associated values to be varied during the test case.
